(19) United States
(12) Patent Application Publication
(10) Pub. No.: US 2008/0209406 A1
(43) Pub. Date: Aug. 28, 2008

(54) History-based call stack construction

(75) Inventor: Robert Weeks O'Callahan, Auckland (NZ)

Correspondence Address: KING & SCHICKLI, PLLC, 247 NORTH BROADWAY, LEXINGTON, KY, 40507, US

(73) Assignee: Novell, Inc.

(21) Appl. No.: 11/711,387

(22) Filed: Feb. 27, 2007

(51) Int. Cl. G06F 9/44

(52) U.S. Cl. 717/131

(57) ABSTRACT

In a computing system environment, methods and apparatus relate to constructing a call stack for a software program based upon a comprehensive recording of an execution history of the software program. Upon defining procedure calls and returns in the execution history, a call stack is constructed for the procedure calls having no corresponding returns, but without reading or otherwise examining allocated stack memory or registers, such as return addresses. In this manner, an accurate call stack can be constructed despite stack memory or registers being erased or corrupted or despite various compiler optimizations eliminating convenience or otherwise complicating the construction. Nuances for defining procedure calls and returns as well as stack pointer values for same are also contemplated. Still other embodiments relate to stand-alone computer program products (on computer-readable media or as a download, or other) or those working in conjunction with other programs.

### FIELD OF THE INVENTION

Generally, the present invention relates to computing system environments involved in constructing call stacks (alternatively named execution stacks, control stacks, function stacks, run-time stacks, or the like). Particularly, it relates to constructing call stacks without regard to the contents of allocated stack memory. In one aspect, call stack construction contemplates a comprehensive recording and examination of program execution history. In another, heuristically defined calls and returns and stack pointer algorithms establish convenient mechanisms for constructing the call stack. In this manner, a fairly accurate call stack can be constructed despite stack memory or registers being erased or corrupted or despite various compiler optimizations eliminating convenience or otherwise complicating construction. Stand-alone computer program products or those working in conjunction with other programs are also contemplated.

### BACKGROUND OF THE INVENTION

Call stacks are used for a variety of reasons in computing environments, such as assisting in debugging programs or conducting security checks regarding program calls, to name a few. In debugging, one of the most difficult call stack construction issues relates to constructing the current call stack by inspecting the contents of allocated stack memory. That is, compilers like to optimize the layout of stack frames, and often it is profitable to partially or totally avoid constructing the standard linked list of frame pointers. Therefore, for debugging optimized code, formats (such as DWARF2) include very complex descriptions of how stack memory should be interpreted. As such, complex guides or keys to interpretation are provided with debuggers. These, however, can be quite cumbersome which inconveniences users. Moreover, certain compiler optimizations, such as reusing stack frames for tail calls, make true call stack reconstruction impossible. This further inconveniences users and frustrates debugging.

Also, for many bodies of optimized code, debug information is not at all available to users. Even if it is, in practice available, this is an error-prone area of debugger implementation and some popular debuggers often display broken call stacks. Worse, some kinds of errors can corrupt stack memory or make it altogether unintelligible by wiping out key registers such as the program counter, stack pointer or frame pointer.

Accordingly, the prior art fails and needs presently exist to enhance construction of call stacks, including making it generally available and doing so accurately. It should also be comprehensive, intelligible and easy to understand even in the face of various compiler optimizations or despite stack memory or registers being erased or corrupted. Naturally, any improvements along such lines should further contemplate good engineering practices, such as relative inexpensiveness, stability, ease of implementation, low complexity, etc.

### SUMMARY OF THE INVENTION

The above-mentioned and other problems become solved by applying the principles and teachings associated with the hereinafter-described construction of call stacks based on program execution history. At a high level, comprehensive recording of the underlying program occurs so that an inspection of the history of program execution reveals calls, not yet returned, for inclusion in the call stack, without examining stack memory. Comprehensive recording can occur in a variety of manners, but is contemplated, in one instance, according to co-pending U.S. patent application Ser. No. 11/643,102, entitled “Methods and Apparatus for Debugging Software,” filed on Dec. 21, 2006, and is incorporated herein by reference, in its entirety.

At a more detailed level, calls and returns are heuristically defined per call instructions, control transfers, or stack pointer values, to name a few. Representatively, calls are any call instructions not calling a target of an immediate next instruction or control transfers to an instruction having a procedure label. Returns, on the other hand, are any of a plurality of returns before a time T2 whereby a stack pointer value at a time T is greater than a stack pointer value at a time T1 (when the call occurred), whereby T1<T≦T2. Once defined, call stack construction includes examining the history to determine which calls have started, but not yet returned.

Still other embodiments relate to stand-alone computer program products (on computer-readable media or as a download, or other) or those working in conjunction with other programs.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a representative computing system environment for constructing call stacks;

FIG. 2 is a screen shot in accordance with the present invention of a representative display of a constructed call stack, including an arrangement of debugging data in a prototype debugger;

FIG. 3 is a flow chart in accordance with the present invention of a high level methodology for constructing a history-based call stack;

FIG. 4 is a diagrammatic view in accordance with the present invention of a representative allocation of registers or memory for a call stack in a computing system environment;

FIG. 5 is a diagrammatic view in accordance with the present invention of a representative arrangement of calls and returns for constructing a history-based call stack;

FIG. 6 is a diagrammatic view in accordance with the present invention of a representative history-based call stack, simplified in detail as compared to the call stack of FIG. 2;

FIGS. 7A-7D are diagrammatic views in accordance with the present invention of representative heuristically defined procedure calls for constructing a history-based call stack;

FIG. 8 is a diagrammatic view in accordance with the present invention of a representative heuristically defined return for constructing a history-based call stack;

FIG. 9 is a diagrammatic view in accordance with the present invention of a representative heuristically defined algorithm for determining a most recent un-returned procedure call; and

FIGS. 10 and 11 are flow charts in accordance with the present invention of representative algorithms for establishing a candidate set of stack pointer values, and filtering same, for procedure calls having no corresponding returns.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus for constructing an history-based call stack are hereinafter described.

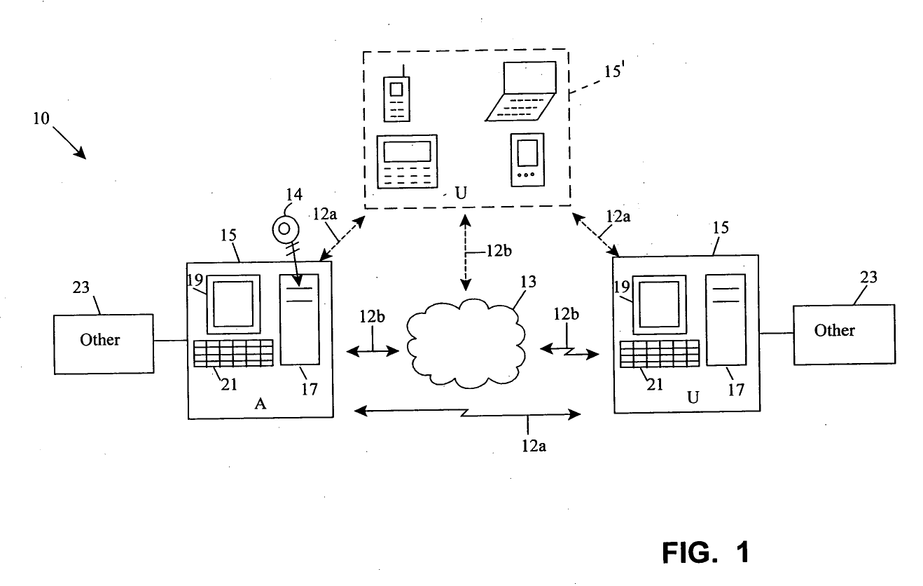

With reference to FIG. 1, a representative environment 10 for constructing call stacks includes one or more computing devices 15 or 15′ available to users. In a traditional sense, an exemplary computing device typifies a stand alone server 17, such as a grid or blade server. Alternatively, an exemplary computing device includes a general or special purpose computing device in the form of a conventional fixed or mobile computer 17 having an attendant monitor 19 and user interface 21. The computer internally includes a central processing unit for a resident operating system, such as DOS, WINDOWS, MACINTOSH, VISTA, UNIX and LINUX, to name a few, a memory, and a bus that couples various internal and external units, e.g., other 23, to one another. Representative other items 23 include, but are not limited to, PDA's, cameras, scanners, printers, microphones, joy sticks, game pads, satellite dishes, hand-held devices, consumer electronics, minicomputers, computer clusters, main frame computers, a message queue, a peer machine, a broadcast antenna, a web server, a palm device, etc. The other items may also be stand alone computing devices 15′ in the environment 10.

In either, storage devices are contemplated and may be remote or local. While the line is not well defined, local storage generally has a relatively quick access time and is used to store frequently accessed data, while remote storage has a much longer access time and is used to store data that is accessed less frequently. The capacity of remote storage is also typically an order of magnitude larger than the capacity of local storage. Regardless, storage is representatively provided for aspects of the invention contemplative of databases, memory or computer executable instructions, e.g., software, software programs, program products, etc., as part of computer readable media, e.g., disk 14 for insertion in a drive of computer 17. Computer executable instructions may also reside in hardware, firmware or combinations in any or all of the depicted devices 15 or 15′.

When described in the context of computer or software program products, it is denoted that items thereof, such as modules, routines, programs, objects, components, data structures, etc., perform particular tasks or implement particular abstract data types within various structures of the computing system which cause a certain function or group of functions. In form, they can be any available media, such as RAM, ROM, EEPROM, CD-ROM, DVD, or other optical disk storage devices, magnetic disk storage devices, floppy disks, or any other medium which can be used to store the items thereof and which can be assessed in the environment. They can even typify downloads from other computing devices or other known or hereafter-invented forms.

In network, the computing devices communicate with one another via wired, wireless or combined connections 12 that are either direct 12a or indirect 12b. If direct, they typify connections within physical or network proximity (e.g., intranet). If indirect, they typify connections such as those found with the internet, satellites, radio transmissions, or the like, and are given nebulously as element 13. In this regard, other contemplated items include servers, routers, peer devices, modems, T1 lines, satellites, microwave relays or the like. The connections may also be local area networks (LAN) and/or wide area networks (WAN) that are presented by way of example and not limitation. The topology is also any of a variety, such as ring, star, bridged, cascaded, meshed, or other known or hereinafter invented arrangement.

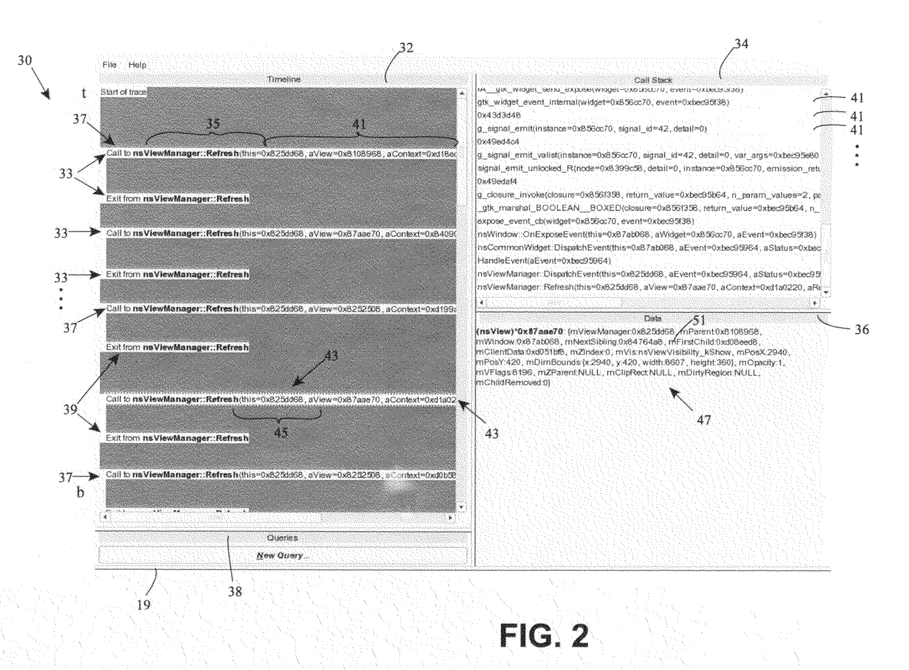

With reference to FIG. 2, skilled artisans will appreciate that the full exploitation of the invention has many possibilities. Thus, a representative screen shot 30 for display to a user on a monitor 19 of a computing device (from a prototype debugger program having a call stack) is shown that illustrates a few of the many possibilities and indicates various inventive motivations that are conformable to other possibilities, not shown. Particularly, FIG. 2 shows a screen shot divided into four display panes 32, 34, 36, 38. In a first pane, 32, a time line of events 33 (Timeline) is found showing events in a debuggee program execution history with time increasing from top (t) to bottom (b). In the example, the user or programmer has run the debuggee program to completion while saving a complete record, then launched the debugger program. The programmer then created a query from pane 38 to populate the Timeline with all invocations of a representative method given as nsViewManager::Refresh, element 35. In turn, each invocation comprises a Call event 37 and an Exit event 39, with the interval between the events being displayed as a bar. Calls are detected, in general, with a query to find all executions of the first instruction of nsViewManager::Refresh; this query returns a set of timestamps each corresponding to a Call event. In each Call event, parameter values 41 are also displayed at the time of the call, using register and memory values reconstructed by the debugger process for the associated timestamp. (In this case, the interpretation of register and memory values is specified by DWARF2 debug information produced by a gcc compiler and consumed by the prototype debugger.)

Continuing with the representative example, the user has selected (such as by double-clicking with a pointing device, such as a mouse) one particular invocation 43 of nsViewManager::Refresh. In so doing, the debugger program or architecture has computed the call stack in pane 34 for that timestamp. Each line 41 in the Call Stack pane 34 displays one stack frame, along with the parameter values for the call that created the stack frame, evaluated at the time of that call. (In contrast, traditional debuggers simply attempted to display parameter values for all active stack frames, but only had access to the current contents of stack memory, not past contents, and therefore may have displayed misleading values, especially if the stack locations holding parameters had been modified after subroutine entry.) The user has also selected or double-clicked on the “this” parameter 45 to nsViewManager::Refresh to inspect that object 47 in the Data pane 36. For the actual display, the debugger program has reconstructed the object's field values at the selected timestamp as is seen in the Data pane 36.

For a further detailed discussion of the prototype, reference by incorporation is taken to the aforementioned co-pending U.S. patent application Ser. No. 11/643,102, entitled “Methods and Apparatus for Debugging Software,” filed on Dec. 21, 2006. This methodology is presented by way of example, not limitation, and other similar methodologies to obtain comprehensive recording of a software program can occur in a variety of manners.

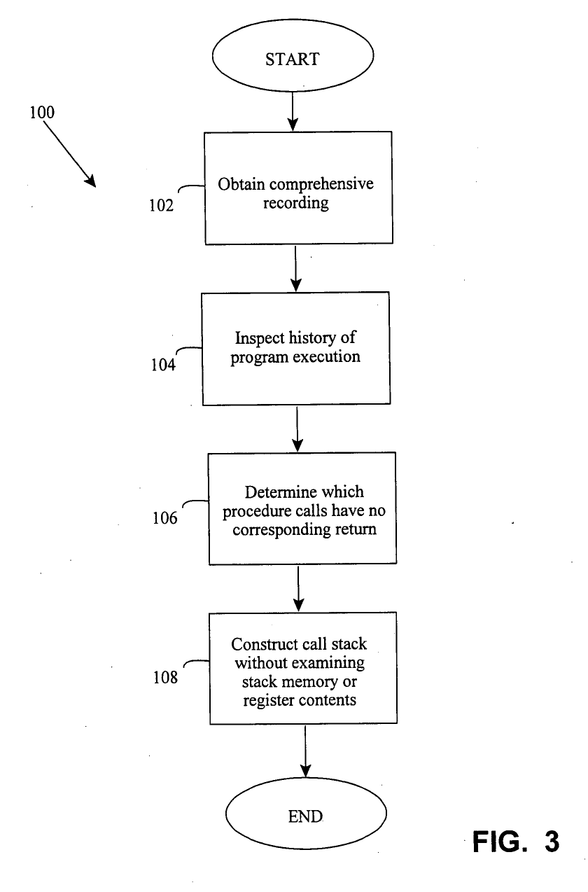

With reference to overall flow, FIG. 3 teaches a high-level process 100 as follows. At step 102, a comprehensive recording of a software program is obtained, whereby constructing a call stack for the software program has utility, such as in debugging (the earlier-seen prototype) or in performing security checks, to name a few. To understand what is meant by comprehensive, the incorporated-by-reference application is one such example. In a basic sense, comprehensive recording is fairly omniscient recording, regardless of program size, and essentially includes tracking or recording all memory and register writes (and flow control) and arranging same to efficiently reconstruct the contents of any memory location or register at any or all periods of time, not just some select period of time, as with prior art recordings.

Thereafter, an inspection of the history of the program's execution is undertaken, step 104, to determine which of the procedure “calls” have no corresponding “returns,” step 106. From this, an order list or call stack is constructed, but is done without regard to examining or otherwise inspecting (collectively “reading”) the contents of the stack memory or registers. As is typical, the CPU of the computing device allocates various memory and/or registers, for those programs desiring the construction of a call stack, and the prior art traditionally references the memory and/or registers to determine where program execution will resume after a call, such as by inspecting or reading a “return address” (as is well known). With complete recording, however, a refreshing approach to call stack construction can be undertaken, as is seen below, and return addresses, for example, become irrelevant to construction.

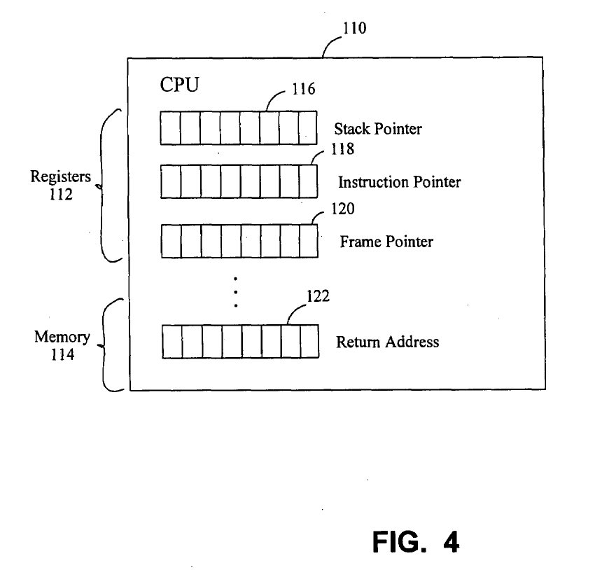

For instance, when a program is interrupted or sampled, such as by a program profiler, debugger, or other executive process, the operating system or CPU stores state information about the program in memory and/or registers. For example, the CPU 110 in FIG. 4 contains a number of registers 112 and memory 114 which can be stored to when an executing process is interrupted. As is typical, the registers may consist of: a value 116 of a stack pointer 204 indicative of a current address of a top element of the call stack; a value 118 indicative of an instruction pointer that points to the address of the instruction executing at the time of the interruption; a value 120 indicative of a frame pointer that points to a current activation record, whereby an activation record (a.k.a. a data frame or a stack frame) is a data structure containing parameters and variables belonging to an executing procedure, and in some cases, links to other activation records; and/or a value 122 indicative of a return address so calls know where to return. With the prior art, construction of a call stack requires reading the memory or return address wherever located, e.g., memory or registers, for otherwise the program execution will get lost. The present invention, however, need not ever read the contents of the memory or find the return address for the construction of the call stack. Naturally, the memory, return address and/or registers allocated to the call stack will be read for a variety of other purposes, but not for the call stack construction.

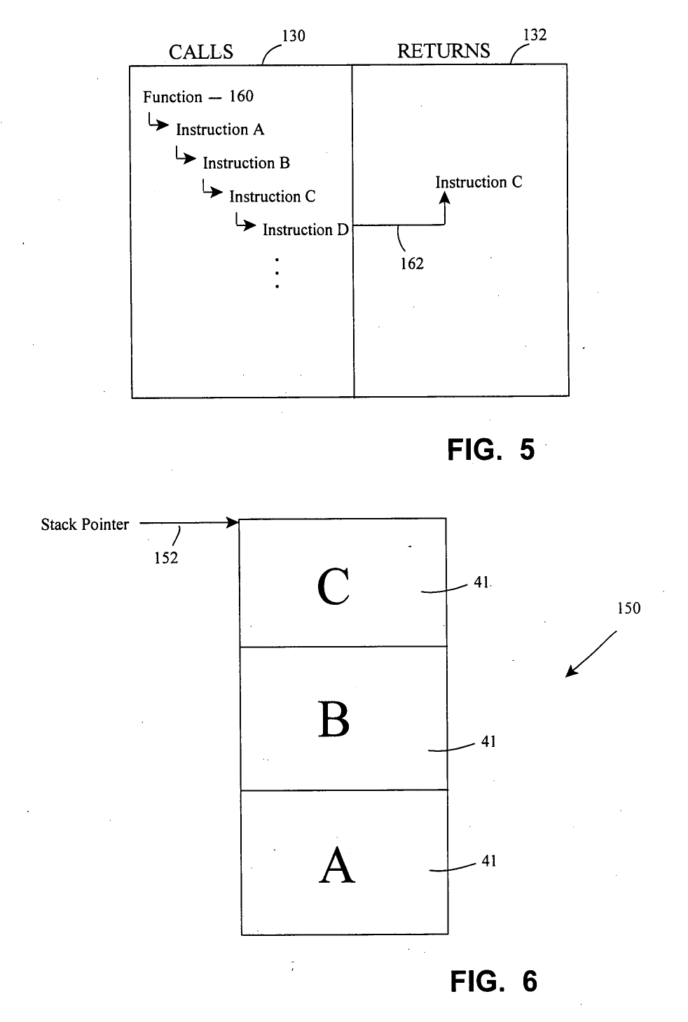

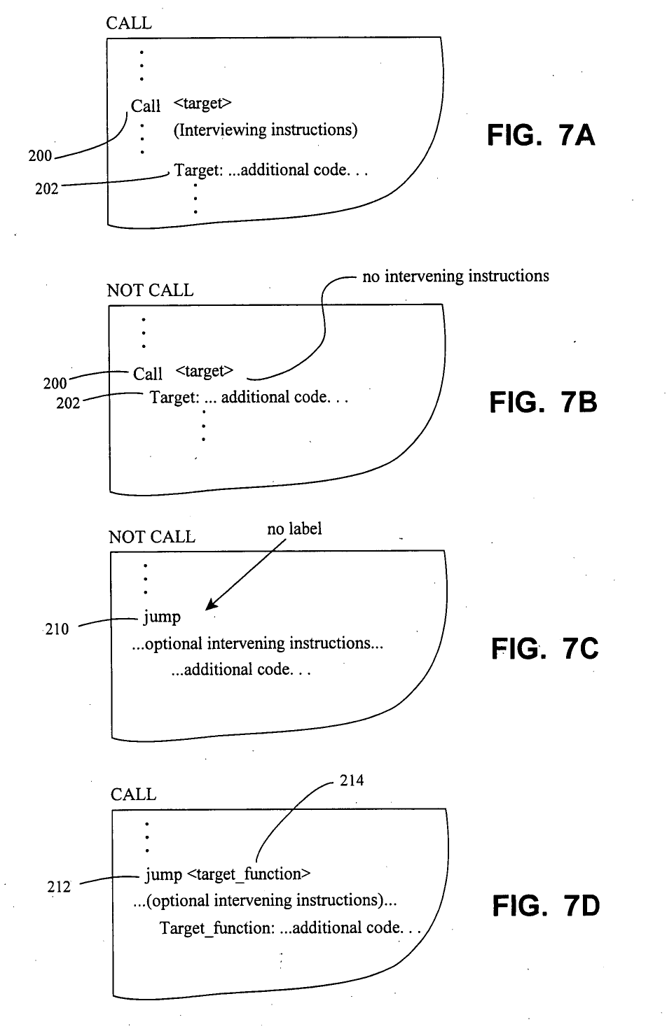

With reference to FIGS. 5 and 6, skilled artisans will appreciate that the execution history of the program is a complicated chain of delegation events. In one instance, it consists of numerous “calls” 130 followed by various “returns” 132. In turn, those calls having no corresponding returns, as of a given sampling time T, are then constructed in an ordered list or call stack 150 as a series of stack frames 41 (e.g., from FIG. 2) and a stack pointer 152, without, however, having need of reading the corresponding stack memory or return address, wherever located.

With more specificity, the example shown indicates a function 160 having a series of procedure calls A, B, C and D. In turn, D has returned 162 back to C, while C has yet to returned back to B. Thus, each of C, B and A have yet to have an answer or return from their call. In turn, C, B and A exist on the call stack 150 at this point in time. As various events unfold, such as C returning back to B, C will be removed from the call stack 150, whereby only B and A will reside. Eventually, B will also return back to A and only A will reside on the list, and so on. Of course, actual call stacks are much larger and will regularly have stack frames thereon growing and shrinking, as the case may be, to reflect the notion of displaying to a user those calls having no corresponding return, with the caveat that no reading of the allocated stack memory or return address occurs. In common parlance, the caller “pushes” onto the call stack, and when a return occurs, it “pops” off the call stack.

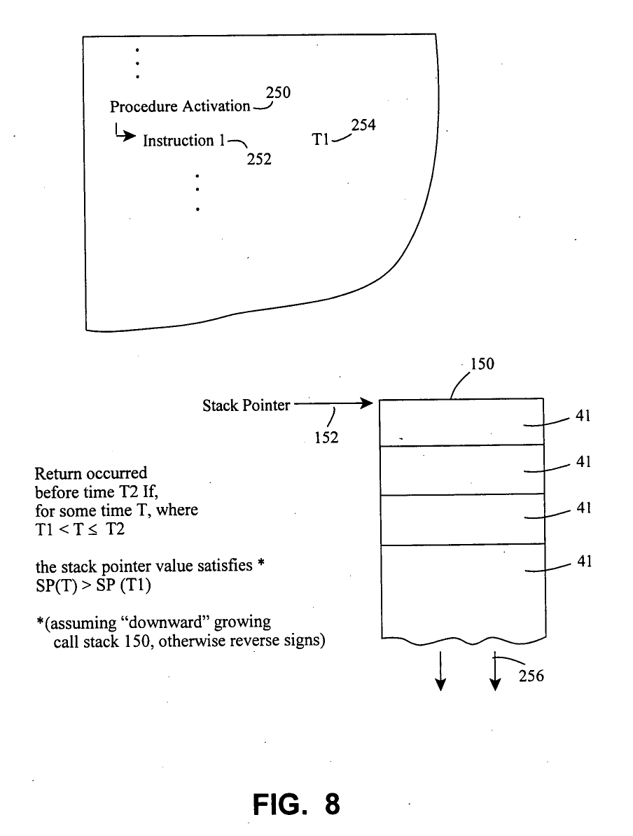

In order to achieve the foregoing, it is desirable to define what constitutes a “call” and a “return.” For the former, a “call” is 1) any call instruction in the execution history not calling a target of an immediate next instruction, or 2) any control transfer in the execution history to an instruction having a procedure label. With reference to FIGS. 7A-7D, examples are given. That is, FIGS. 7A and 7B show call <target> 200, including a target 202, with additional code appropriate for the target. To the extent intervening instructions exist between the call target 200 and the target itself, it is considered a “call” (FIG. 7A). Otherwise, it is not considered a call (FIG. 7B) for purposes of constructing a call stack. On the other hand, FIGS. 7C and 7D show a control transfer 210, 212 (in this case “jump”). To the extent the control transfer is to a procedure LABEL 214 (in this case <target_function>), as in FIG. 7D, it is considered a “call.” Otherwise, it is not a “call” for purposes of constructing a call stack, as in FIG. 7C. Of course, these definitions are heuristics, but very effective, and skilled artisans will be able to contemplate and utilize others.

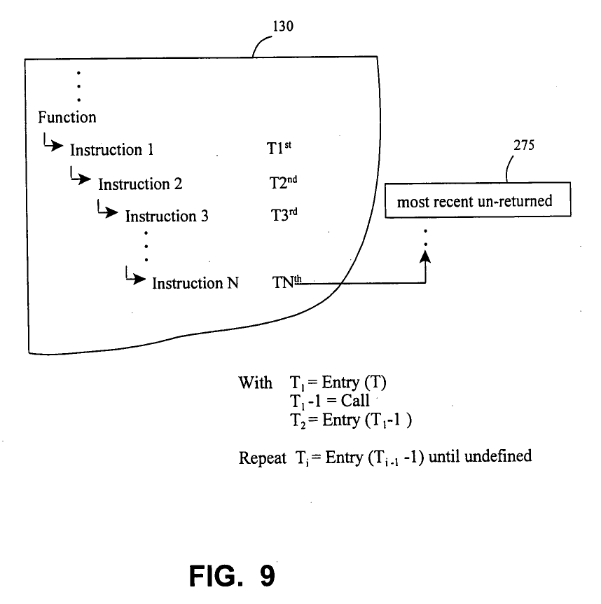

For the latter, the “return,” it is a bit more complicated to define. Nonetheless, it is expressed herein relative to other terms, such as to stack pointer values 116 (FIG. 4) or other values. That is, FIG. 8 shows a various procedure activation 250 having a first instruction 252 occurring at a timestamp 254 given generically as T1. In turn, a call stack 150 includes a plurality of stack frames 41 and a stack pointer 152 having a stack pointer value 116 (FIG. 4). In this implementation, it is said that a “return” has occurred before some time T2, if, for some time T, whereby T1<T≦T2, the stack pointer (SP) value at time T is greater than the stack pointer value at time T1, i.e., SP(T)>SP(T1). In other words, a procedure activation returns when the stack pointer first exceeds the value it had on procedure entry. This happens in practice when a return pops off the return address, or due to any other kind of stack unwinding such as with C++ exceptions or C's longjmp, or other. Regardless, this all assumes, however, the call stack “grows” in a “downward” direction 256 as is typical with many Intel brand architectures of the Pentium, x86 class or the like. For other than downward growing call stacks, skilled artisans will know to alter the equations in order to satisfy them.

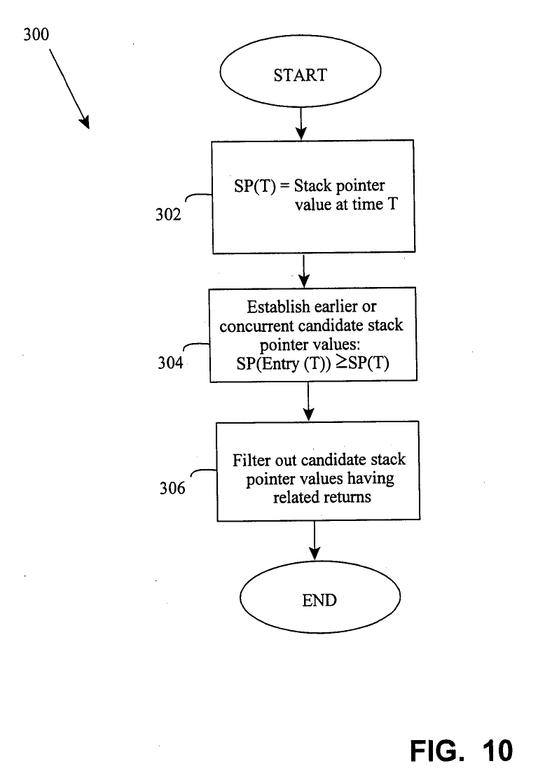

With reference to FIG. 9, an entry algorithm Entry(T) is needed to determine, for a given timestamp T, the timestamp of the first instruction of the activation current at T. In other words, the most recent procedure entry 275 that has not yet returned, and is undefined if there is no such procedure entry. At a high level, this consists of iterating a backward progression to determine a timestamp of a most recent of the procedure calls have no corresponding returns. Then, the Entry can be iteratively applied to reconstruct the call stack for a given time T. First, find the call to the current procedure, say let T₁=Entry(T). Then, the instruction at T₁−1 corresponds to the call instruction for same, so find the entry to its procedure, such as by letting T₂=Entry(T₁−1). Thereafter, repeat setting Tᵢ=Entry(Tᵢ₋₁−1) until Entry(Tᵢ₋₁−1) is undefined.

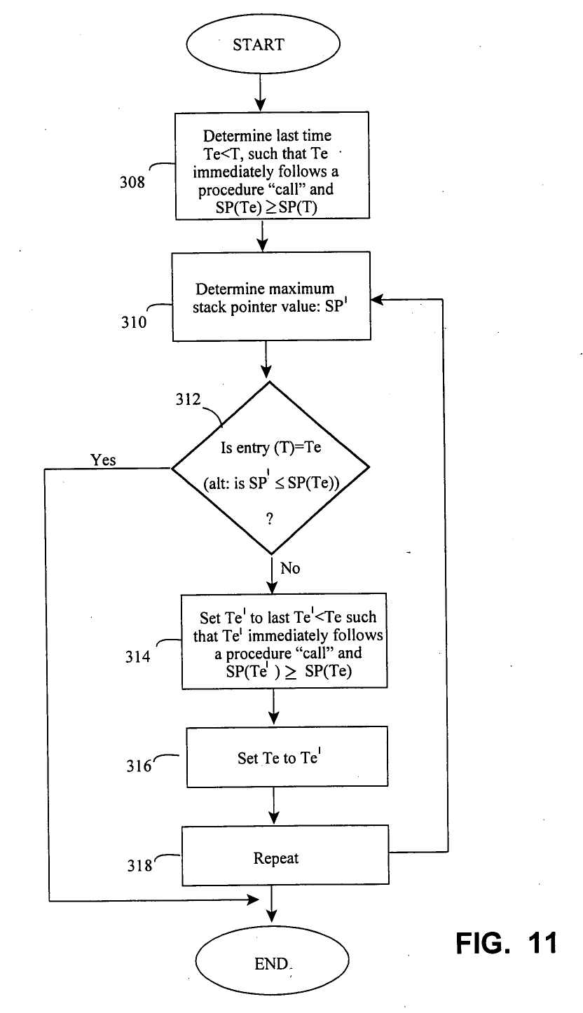

From here, FIG. 10 shows the invention methodology 300 as establishing earlier or concurrent stack pointer values (e.g., 116, FIG. 4) as a candidate set of stack pointer values at time (Entry (T)) greater than or equal to those at time T, e.g., SP (Entry (T))≧SP(T), step 304, (wherein SP(T) is earlier defined as the stack pointer value at time T, step 302). From the candidate set, the stack pointer values are whittled or filtered out to determine which have corresponding or related returns and which do not, step 306. In other words, methodology 300 includes: let SP(T) denote the value of the stack pointer at time T; to determine Entry(T), note that SP(Entry(T)) must be greater than or equal to SP(T), a look occurs backward from time T for procedure calls where the after-call stack pointer is greater than or equal to SP(T).

With reference to FIG. 11, this is done efficiently by:

1. Determining a last time Te<T such that Te immediately follows a procedure “call” and the stack pointer value at time Te is greater than or equal to the stack pointer value at time T, i.e., SP(Te)≧SP(T), step 308. (For efficiency and to handle multiple thread stacks, it is preferred to also bound SP(Tₑ) from above, to the top of a thread's stack, which can be computed from recorded address space maps in memory.)

2. In that Te may actually be the start of a procedure that terminated before time T, a maximum stack pointer value SP′ is determined to confirm or deny this, step 310, e.g., SP′=max {SP(T′)|Te<T′≦T}

3. At step 312, if Entry (T)=Te, or SP′≦SP(Te), then Te did not return before time T and no further look backward is necessary.

4. Otherwise, Te′ is set to the last Te′<Te, such that Te′ immediately follows a procedure call and the stack pointer value for time Te′ is greater than or equal to the stack pointer value at time Te, i.e., SP(Te′)≧SP(Te), step 314.

5. Upon then setting Te equal to Te′, step 316, the process can be repeated, step 318. (There is little point, however, in considering SP(Te)>SP(Te′)≧SP(T) because the Te′ procedure call must have returned before Te and thus T.)

As skilled artisans will appreciate, the computation of SP′ could be expensive in the computing environment. To bound that cost, various schemes may be introduced. For instance, maximum stack pointer values could be identified per various boundaries of the comprehensive recording, and thence only a comparison of the maximum of one boundary need occur relative to a maximum of another boundary. A comparison of maximums to other maximums, so to speak. Naturally, other efficiencies will be readily imagined upon inspection of the incorporated-by-reference document.

Ultimately, the foregoing approach to call stack construction is extremely robust. Among other things, it can construct the call stack for time T even when stack memory and all registers except the stack pointer have been previously zeroed out (erased) or corrupted before the time of construction. Also, if the stack pointer is invalid (e.g., outside the thread stack area), the invention contemplates searching backwards for a time when the stack pointer is valid. It is also robust to compiler transformations, e.g., it requires no knowledge of stack frame layout, no knowledge of which instructions belong to which procedures (i.e., it is robust to arbitrary code placement optimizations), and it can reconstruct the actual call chain in the presence of tail call optimization. It also works certainly when the compiler has changed the layout of stack frames but debug information has been removed from the executable file or when some stack frames have been completely removed by compiler during tail call optimizations.

Finally, one of ordinary skill in the art will recognize that additional embodiments are also possible without departing from the teachings of the present invention. This detailed description, and particularly the specific details of the exemplary embodiments disclosed herein, is given primarily for clarity of understanding, and no unnecessary limitations are to be implied, for modifications will become obvious to those skilled in the art upon reading this disclosure and may be made without departing from the spirit or scope of the invention. Relatively apparent modifications, of course, include combining the various features of one or more figures with the features of one or more of other figures.

1. In a computing environment, a method of constructing a call stack for a software program, the call stack having allocated memory or registers in the computing environment, comprising:
obtaining a comprehensive recording of an execution history of the program;
determining which procedure calls have no corresponding returns, the returns having a corresponding return address in either the allocated memory or registers; and
for display to a user in the computing environment, constructing a list of the determined procedure calls having no corresponding returns without reading the return address in the allocated memory or registers.

2. The method of claim 1, further including defining the procedure calls as any of a plurality of call instructions in the execution history not calling a target of an immediate next instruction.

3. The method of claim 1, further including defining the procedure calls as any of a plurality of control transfers in the execution history to an instruction having a procedure label.

4. The method of claim 1, further including defining the returns as any of a plurality of returns before a time T2 whereby a stack pointer value at a time T is greater than a stack pointer value at a time T1, whereby T1<T≦T2.

5. The method of claim 1, further including iterating a backward progression to determine a timestamp of a most recent of the procedure calls have no corresponding returns.

6. The method of claim 1, further including establishing a candidate set of stack pointer values earlier or concurrent to a time corresponding to the constructing the list of the determined procedure calls having no corresponding returns.

7. The method of claim 6, further including filtering out stack pointer values having related returns from the candidate set of stack pointer values.

8. The method of claim 7, wherein the filtering out further includes determining a last time less than the time such that the last time immediately follows one of the procedure calls and a stack pointer value for the last time is greater than a stack pointer value for the time.

9. A computer program product having computer-executable instructions for performing the determining and constructing steps recited in claim 1.

10. In a computing environment, a method of constructing a call stack for a software program, comprising:
allocating memory or registers in the computing environment to the call stack;
recording an execution history of the program;
determining which procedure calls of the execution history have no corresponding returns, the returns having a corresponding return address in either the allocated memory or registers;
constructing a list of the determined procedure calls having no corresponding returns without reading the return address in the allocated memory or registers; and
displaying the constructed list as a call stack to a user in the computing environment.

11. The method of claim 10, further including defining the procedure calls as any of a plurality of call instructions in the execution history not calling a target of an immediate next instruction.

12. The method of claim 10, further including defining the procedure calls as any of a plurality of control transfers in the execution history to an instruction having a procedure label.

13. The method of claim 10, further including defining the returns as any of a plurality of returns before a time T2 whereby a stack pointer value at a time T is greater than a stack pointer value at a time T1, whereby T1<T≦T2.

14. The method of claim 10, further including iterating a backward progression to determine a timestamp of a most recent of the procedure calls have no corresponding returns.

15. The method of claim 1, further including establishing a candidate set of stack pointer values earlier or concurrent to a time corresponding to the constructing the list of the determined procedure calls having no corresponding returns.

16. A computer program product having computer-executable instructions for installation on a computing device for constructing a call stack for a software program on or in communication with the computing device, the call stack having allocated memory or registers in the computing environment, comprising:
a first component functional to understand a comprehensive recording of an execution history of the program;
a second component to determine which procedure calls of the execution history have no corresponding returns, the returns having a corresponding return address in either the allocated memory or registers;
a third component to construct a stacked list of the determined procedure calls having no corresponding returns without reading any of the return addresses in the allocated memory or registers; and
a fourth component functional to cause display to a user of the stacked list on a monitor of the computing device.

17. The computer program product of claim 16, further including a fifth component setting the procedure calls as any of a plurality of call instructions in the execution history not calling a target of an immediate next instruction.

18. The computer program product of claim 16, further including a fifth component setting the procedure calls as any of a plurality of control transfers in the execution history to an instruction having a procedure label.

19. The computer program product of claim 16, further including a fifth component setting the returns as any of a plurality of returns before a time T2 whereby a stack pointer value at a time T is greater than a stack pointer value at a time T1, whereby T1<T≦T2.

20. The computer program product of claim 16, further including a fifth component iterating a backward progression to determine a timestamp of a most recent of the procedure calls have no corresponding returns.

21. The computer program product of claim 16, further including a fifth component establishing a candidate set of stack pointer values earlier or concurrent to a time corresponding to the constructing the list of the determined procedure calls having no corresponding returns.

22. The computer program product of claim 21, further including a fifth component filtering out stack pointer values having related returns from the candidate set of stack pointer values.

23. The computer program product of claim 22, further including a fifth component determining a last time less than the time such that the last time immediately follows one of the procedure calls and a stack pointer value for the last time is greater than a stack pointer value for the time.
